(19) United States
(12) Patent Application Publication
(10) Pub. No.: US 2017/0158400 A1
(43) Pub. Date: Jun. 8, 2017

(54) PRODUCT PACKAGING WITH COC-COC SEALING INTERFACE

(71) Applicant: Bemis Company, Inc., Neenah, WI (US)

(72) Inventors: Michael Drew Priscal, Neenah, WI (US); Arthya Puguh, Neenah, WI (US)

(21) Appl. No.: 14/961,486

(22) Filed: Dec. 7, 2015

(51) Int. Cl. B65D 65/40; B32B 27/32; B32B 27/08; B65D 75/36

(52) U.S. Cl. CPC B65D 65/40; B65D 75/36; B32B 27/325; B32B 27/32; B32B 27/08; B32B 2553/00

(57) ABSTRACT

A package includes a base component having a product contacting layer including at least 50% by weight of a cyclic olefin copolymer, and a lidding component having a product contacting layer including at least 50% by weight of a cyclic olefin copolymer. The product contacting layer of the base component is sealed to the product contacting layer of the lidding component such that a cavity is formed.

### BACKGROUND

The present application relates generally to packaging materials and configurations for commercial packaging operations. According to one particular embodiment, the packaging may be provided in the form of tray and lid packaging, container and lid packaging, blister packaging, or “push-through” packaging.

Blister packaging is employed widely for commercial packaging of food products, personal care products, and human health products such as pharmaceuticals, and medical devices or precision instruments. The use of this type of packaging has become widespread mainly due to the ability to incorporate suitable moisture, dust, ultraviolet (UV), and/or gas barriers into the packages when such properties are desired for maintaining the integrity or efficacy of the product contained therein. For example, blister packaging is extensively used in the pharmaceutical industry for packaging of medicaments or the like in capsule, lozenge, or pill form because the integrity of the medicament can be maintained through the proper selection of materials used to form the packages.

For preparing blister packages or push-through packages, generally a thermoplastic film is first processed by vacuum forming or pneumatic forming so as to form blisters or cavities thereon, namely portions having a predetermined contour that generally corresponds to the size and shape of each specific product to be received or contained therein. After the so-blistered film has been solidified, each blister is charged with the product to be packaged and a second or lidding film is then covered over each blister and sealed to the first film. The second lidding film is often a laminate material which can be ruptured by a simple finger-rupture or peeled off from the first film to allow access to a packaged item. Conventional materials used for forming the blistered film have included transparent plastics such as polyvinylchloride (PVC), polyvinylidene chloride (PVdC), and polychlorotrifluoroethylene (PCTFE), commonly referred to as ACLAR® (Honeywell/Allied Signal).

Packaging for pharmaceuticals or other moisture-sensitive articles desirably exhibits not only low moisture permeability, but also other properties such as chemical inertness, clarity, rigidity, and/or uniform thickness. Conventional materials for such blister packaging generally suffer from certain shortcomings, however. For example, the use of polyvinylchloride (PVC) and polyvinylidene chloride (PVdC) have been shown to have poor and/or insufficient moisture-proofing properties required by the pharmaceutical industry. While ACLAR® exhibits relatively low moisture vapor transmission, its use in blister packaging is relatively costly as compared to alternative materials. Additionally, in some cases, undesirable migration of chemicals or other components of the product, such as pharmacological active agents or excipients, between the product and the packaging materials (e.g., film, film layer, etc.) may occur (i.e., scalping or leaching).

There is therefore a need in the art for improved packaging materials and configurations that may provide sufficient moisture vapor barrier, anti-scalping, and chemical inertness properties and that is aesthetically pleasing enough to present the products contained therein while being cost effective to manufacture.

### SUMMARY

One embodiment relates to a package including: a base component comprising product contacting layer comprising at least 50% by weight of a cyclic olefin copolymer, and a lidding component comprising product contacting layer comprising at least 50% by weight of a cyclic olefin copolymer. The product contacting layer of the base component is sealed to the product contacting layer of the lidding component such that a cavity is formed.

The base component may be a multilayer thermoplastic film. The multilayer thermoplastic film may include: the product contacting layer comprising at least 50% by weight of the cyclic olefin copolymer, a first interior layer, a core layer, a second interior layer, and an exterior layer. The exterior layer may include at least one of cyclic olefin copolymer (COC), polypropylene (PP), high impact polystyrene (HIPS), general purpose polystyrene (GPPS), styrene block copolymer (SBC), polyethylene terephthalate (PET), oriented polyethylene terephthalate (OPET), amorphous polyethylene terephthalate (APET), glycol-modified polyethylene terephthalate (PETG), biaxially oriented nylon (BON), or polylactic acid (PLA). The first interior layer and the second interior layer may each comprise a high density polyethylene nucleation additive, and may each further include a hydrocarbon resin. The first interior layer and the second interior layer each may include a bimodal high density polyethylene having a distribution of a low molecular weight region and a high molecular weight region. The first interior layer and the second interior layer each may be in direct contact with an exterior layer. The core layer may include an ethylene vinyl acetate copolymer, and may be in direct contact with the first interior layer and the second interior layer. The exterior layer of the base component may include at least 50% by weight of a cyclic olefin copolymer.

The lidding component of the package may include: an optional exterior layer; a barrier layer; and the product contacting layer comprising at least 90% by weight of a cyclic olefin copolymer. The barrier layer may be a foil layer. The exterior layer may be at least one of paper, biaxially oriented nylon, biaxially oriented polypropylene, or oriented polyethylene terephthalate. The lidding component may further include an interior layer disposed between the exterior layer and the barrier layer. The interior layer may include at least one of polyethylene and an adhesive.

The cyclic olefin copolymer of at least one of the base component or the lidding component may include norbornene and ethylene monomers. The seal between the product contacting layer of the base component and the product contacting layer of the lidding component may have a seal strength of at least 800 grams force per inch.

A second embodiment relates to a lidding component for a package, the lidding component including: an optional exterior layer, a barrier layer, and a product contacting layer comprising at least 50% by weight of a cyclic olefin copolymer. The product contacting layer being configured to seal to a product contacting layer of a base component. The barrier layer may be a foil layer. The exterior layer may be at least one of paper, biaxially oriented nylon, biaxially oriented polypropylene, or oriented polyethylene terephthalate. The lidding component may further include an interior layer disposed between the exterior layer and the barrier layer. The interior layer may include at least one of polyethylene and an adhesive.

A third embodiment relates to a method of forming a package. The method includes: sealing a product contacting layer comprising at least 50% by weight of a cyclic olefin copolymer of a base component to a product contacting layer comprising at least 50% by weight of a cyclic olefin copolymer of a lidding component to form a cavity. The method may further include forming the base component by a blown coextrusion process. The base component may be any of the base components described above. The method may also further include forming the lidding component by lamination process. The lidding component may be any of the lidding components described above. The sealing may be a heat sealing process.

### BRIEF DESCRIPTION OF THE DRAWINGS

References are made to the accompanying drawings that form a part of this disclosure, and which illustrate the embodiments in which the systems and methods described in this specification can be practiced.

FIG. 1 is a schematic view of a package according to a non-exclusive and non-limiting exemplary embodiment, shown in the form of a blister package.

FIG. 2 is a cross-sectional view of the package of FIG. 1 taken along line A-A.

FIG. 3 is a cross-sectional view of a portion of a package according to another exemplary embodiment.

FIG. 4 is a cross-sectional view of a portion of a package according to another exemplary embodiment.

FIG. 5 is a cross-sectional view of a portion of a package according to another exemplary embodiment.

FIG. 6 is a cross-sectional view of a portion of a package according to another exemplary embodiment.

### DETAILED DESCRIPTION

Embodiments described and depicted herein relate generally to packages formed from a base component (e.g., a blister portion, tray portion, or container portion in which one or more products to be packaged are contained or housed) and a lidding component (e.g., a cover, film, or lid coupled to the base component for sealing or closing the product(s) within the base component). The base component and the lidding component may be separate components before they are sealed together. It should be understood, however, that the concepts described herein may also apply to other types of packaging, which have a plurality of components to be joined or sealed together in manners similar to those described herein, and such other packaging types are intended to fall within the scope of the present disclosure.

According to an exemplary embodiment, the base component and the lidding component are independently formed from multilayer polymeric materials, and the layers of the base component and lidding component in facing contact with each other (i.e., the sealing surfaces of each) include a cyclic olefin copolymer (COC) material. Such facing layers may also be referred to herein as a product contact layer or a product contacting layer, since the contained product(s) may contact, directly or indirectly, all or a portion of such layer when the product(s) are contained within the package.

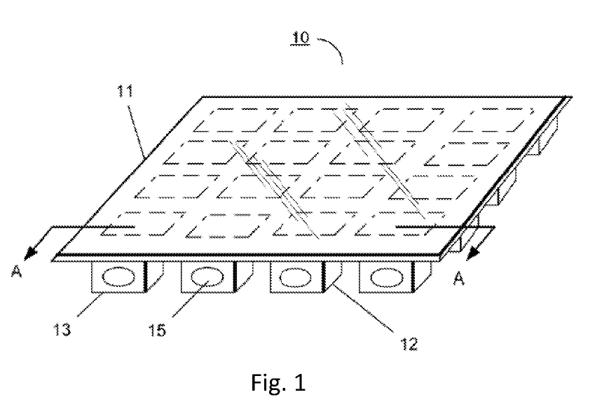

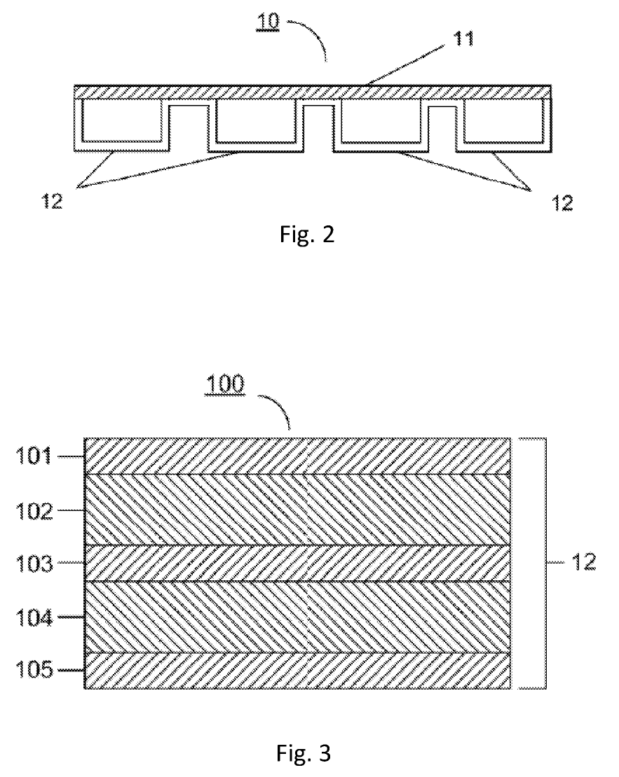

A representative blister package 10 as described herein is shown in FIGS. 1 and 2 according to one non-exclusive and non-limiting exemplary embodiment. Blister package 10 includes a thermoformed base component 12 and a lidding component 11. The base component 12 and the lidding component 11 are sealed together to form sealed flange regions surrounding cavities 13 (e.g., compartments, storage areas, openings, chambers, channels, etc.). The cavities 13 define individual areas or regions for receiving and containing one or more products 15, such as a tablet, patch, or cartridge. As will be appreciated by those reviewing the present disclosure, any of a wide variety of product types may be contained within the blister package 10.

According to one particular embodiment, the product may be a replacement cartridge for an electronic cigarette system. Alternative packages that may be formed using the base component and the lidding component described herein include tray and lid packages and container and lid packages.

### Base Component

As used throughout this disclosure, the term “base component” refers to multilayer thermoplastic film or a roll of multilayer thermoplastic film both of which may be thermoformed, partially thermoformed, or not thermoformed at all. The multilayer thermoplastic film may include layers that do not include a thermoplastic materials, such as metal foils or paper. In one exemplary embodiment, the sequence of layers in the multilayer thermoplastic film of the base component is palindromic. As used throughout this application, the term “palindromic” refers to a multilayer film, the layers of which are substantially symmetrical. Non-limiting examples of palindromic films are films or sheets having the layer sequence of configurations: A/B/A or A/B/B/A or A/B/C/B/A or A/B/C/D/C/B/A or A/B/C/B/D/B/C/B/A or A/B/E/D/E/B/C/B/E/D/E/B/A, etc. A palindromic thermoplastic film may be coextruded as a symmetrical cast or a blown film using coextrusion methods generally well known in the art. An alternative method of producing palindromic films is by the use of blown coextrusion of non-symmetrical film or sheet structures followed by collapsing the blown bubble around a central core layer. An exemplary method of producing a base component may include producing a single-bubble blown film by forcing a non-palindromic film composition through a multi-manifold circular die head to form a cylindrical bubble. The cylindrical bubble may be immediately quenched, such as by a cooled water bath, solid surface, and/or air, and collapsed onto itself and formed into a palindromic film.

According to another exemplary embodiment, the sequence of layers in the multilayer thermoplastic film of the base component is non-palindromic. An example of a layer sequence configuration of a non-palindromic film would be A/B/C or AB/C/A.

In one embodiment, the thermoformed base component may be characterized as a palindromic film formed from a non-symmetrical film having a generic layer sequence configuration of A/B/C which is coextruded by blown film coextrusion techniques and collapsed upon itself to produce a layer sequence configuration of AB/CB/A. In this embodiment, the thermoformed base component includes a film where layer A is an exterior layer comprising a cyclic olefin copolymer (COC). Layer B may be an interior layer comprising at least one of a high density polyethylene (HDPE), a blend of high density polyethylene, a high density polyethylene nucleation additive and optionally, a hydrocarbon resin, a bimodal high density polyethylene having a distribution of a low molecular weight region and a high molecular weight region, or a high density polyethylene (HDPE) and may have a thickness of between about 38.1 μm and about 190.5 μm (about 1.5 mil to about 7.5 mil). Layer C is a central core layer. The central core layer C may be any suitable polymeric material which can be blown coextruded and collapsed upon itself. One non-limiting example of such polymeric materials is ethylene vinyl acetate copolymer (EVA).

In another embodiment, the thermoformed base component may be characterized as a non-palindromic film having a layer sequence configuration of A/B/C/B/D which is coextruded by blown film coextrusion techniques and is not collapsed upon itself. In this embodiment, the thermoformed base component includes a film where layer A is an exterior layer comprising a material selected from the group consisting of cyclic olefin copolymer (COC). Layer B may be an interior layer comprising a high density polyethylene (HDPE), a blend of high density polyethylene, high density polyethylene nucleation additive and optionally, a hydrocarbon resin (HDPE-Blend), a bimodal high density polyethylene having a distribution of a low molecular weight region and a high molecular weight region (HDPE-Bimodal), or a high density polyethylene and has a thickness of between about 38.1 μm to about 190.5 μm (about 1.5 mil to about 7.5 mil). Layer C is a central core layer, and layer D is an exterior layer comprising a different material than layer A. Layer D may include at least one of polypropylene (PP), high impact polystyrene (HIPS), general purpose polystyrene (GPPS), styrene block copolymer (SBC), polyethylene terephthalate (PET), oriented polyethylene terephthalate (OPET), amorphous polyethylene terephthalate (APET), glycol-modified polyethylene terephthalate (PETG) biaxially oriented nylon (BON), and polylactic acid (PLA). Core layer C may be any thermoplastic material. In one particular embodiment, core layer C comprises ethylene vinyl acetate copolymer (EVA).

The thermoformed base component may also include additional film layers. For example, the base component may include additional interior layers, such as an oxygen barrier and a moisture barrier, disposed between the external layers and the core layer. Additionally, the base component may include tie layers disposed between the interior layers of the multilayer film.

The multilayer thermoplastic film of the thermoformed base component may include any number of film layers and film layer compositions depending upon both functional and aesthetic requirements of the base component. It is desirable that the multilayer thermoplastic film includes one or more film layers which are barrier materials and substantially chemically insert when in contact with a product. The term “barrier” refers to a material that controls permeability of one or more elements through a film structure including moisture, chemicals, heat, odor, and oxygen or other gases. A barrier material may be provided by a single film layer or multiple film layers acting individually or in concert with each other, respectively. The phrase “substantially chemically insert” as used herein refers to materials that generally are not reactive with the product with which it comes into contact with and does not leech chemical ingredients into the product with which it comes into contact. According to an exemplary embodiment, the base component comprises a multilayer thermoplastic film which provides an average water vapor transmission rate of less than about 0.500 g/m²/day or less than about 0.250 g/m²/day or less than about 150 g/m²/day or less than about 0.131 g/m²/day or less than about 0.110 g/m²/day at 100° F. (37.8° C.) and 90% relative humidity and has a thickness of about 10 mil (about 254 micron) before being thermoformed. The aforementioned features may be achieved by a multilayer thermoplastic film comprising at least 3, 4, 5, 7, 8, 9, 10, 11, 12, 13, or more layers.

In one embodiment as depicted in FIG. 3, thermoformed base component 12 comprises a multilayer thermoplastic film 100 comprising a five-layer structure of a first exterior layer 101, a first interior layer 102, a central core layer 103, a second interior layer 104, and a second exterior layer 105. In one embodiment, first and second exterior layers 101 and 105 comprise the same materials. In another embodiment, first and second exterior layers 101 and 105 comprise different materials. The first exterior layer 101 is a product contacting layer that includes a cyclic olefin copolymer (COC).

For example, in one embodiment, first and second exterior layers 101 and 105 each comprise a cyclic olefin copolymer (COC). The COC contained in the first exterior layer 101 may be the same as the COC contained in the second exterior layer 105. Alternatively, the COC contained in the first exterior layer 101 may be different than the COC contained in the second exterior layer 105. First and second interior layers 102 and 104 each comprise at least one of a high density polyethylene (HDPE), a blend of a high density polyethylene and a high density polyethylene nucleation additive with an optional hydrocarbon resin (HDPE-Blend), or a bimodal high density polyethylene having a distribution of a low molecular weight region and a high molecular weight region (HDPE-Bimodal), and have a thickness of between about 38.1 μm to about 190.5 μm (about 1.5 mil to about 7.5 mil). Core layer 103 comprises ethylene vinyl acetate copolymer (EVA). Alternatively, the first exterior layer 101 comprises cyclic olefin copolymer (COC) and the second exterior layer 105 comprises a different material than first exterior layer 101 which includes at least one of polypropylene (PP); aromatic polyesters such as, but not limited to, polyethylene terephthalate (PET), oriented polyethylene terephthalate (OPET), amorphous polyethylene terephthalate (APET), glycol-modified polyethylene terephthalate (PETG); aliphatic polyesters such as, but not limited to, polylactic acid (PLA); polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D); biaxially oriented nylon (BON); or polystyrenes such as, but not limited to, high impact polystyrene (HIPS), general purpose polystyrene (GPPS), and styrene block copolymer (SBC).

As used herein, the term “cyclic olefin copolymer” refers to copolymers having at least one norbornene structural moiety within the repeating backbone of the polymer. Suitable COCs for use in the present invention may have a heat deflection temperature under load (0.45 MPa) of at least about 75° C., 130° C., 150° C., 170° C., or more. The COCs utilized herein may have a glass transition temperature in a range from about 50° C. to about 178° C. such as from about 65° C. to about 138° C. Examples of commercially-available cyclic olefin copolymers include, but are not limited to, the TOPAS® family of resins which is supplied by Celanese Corporation (Irving, Tex., USA). The COC containing product contact layers are anti-scalping layers, in that they resist migration of chemicals, such as active agents, from the product to the packaging materials (either through direct contact with the product or through volatiles components from the product impinging on or migrating to the packaging material). Such migration of chemicals from the product to packaging materials is commonly referred to as “scalping.” The COC containing product contact layers are advantageously characterized as being anti-scalping with regard to at least nicotine and fentanyl.

As utilized herein, a product contacting layer of a film is considered to serve as an effective “anti-scalping layer” for pharmacological active agents if (i) a lower amount of an active agent migrates into the product contacting layer of the film (the test film) than migrates into a substantially similar film having a polyethylene (PE), such as a linear low density polyethylene homopolymer, product contacting layer (the reference film) when a product containing the active agent is in direct contact with the product contacting layers of the test and reference films; or (ii) an amount of the active agent that migrates into the product contacting layer of the film (the test film) is not more than 15% greater than migrates into a substantially similar film having a Barex® product contacting layer (the reference film) when a product containing the active agent is in direct contact with the product contacting layers of the test and reference films. Preferably, the product is sealed in a cavity formed, at least in part, by the test film and the product is sealed in a cavity formed, at least in part, by the reference film. The sealed product can be stored under identical conditions prior to testing to determine whether less active agent has migrated into the product contacting layer of the test film than the reference film. A film may still have anti-scalping properties even if it is not an effective anti-scalping layer as defined above. For example, a film that is not an effective anti-scalping layer for pharmacological active agents may exhibit sufficient anti-scalping properties for other applications.

The COCs utilized herein may be are commercially available amorphous, transparent copolymers of ethylene with norbornene made by polymerization with a metallocene catalyst. These commercially available COCs reportedly have high transparency and gloss, excellent moisture barrier and aroma barrier properties, high stiffness, high strength, excellent biocompatibility and inertness and are easy to extrude and thermoform. The COC materials may have an ethylene-norbornene comonomer content of about 20 to about 40 mole % ethylene and about 30 to about 60 mole % norbornene. In some embodiments, the COC materials described herein may include polymeric units derived from essentially only ethylene and norbornene comonomers.

A “product contacting layer” refers to a layer that under typical storage conditions some portion of the product or an active agent contained within the product will contact the layer. The active agent may be in direct contact with the product contacting layer or may be in indirect contact with the product contacting layer. Indirect contact between the active agent and the product contacting layer can occur, for example, due to volatilization of the active agent or an active agent carrier within the package to cause the active agent, which is not stored in direct contact with the product contacting layer, to contact the layer. The product contacting layer includes at least 50% by weight of COC, such as at least 75% by weight of COC, at least 90% by weight of COC, at least 95% by weight COC, or 100% by weight COC. In the case that the product contacting layer contains less than 50% by weight COC, the anti-scalping properties of the product contacting layer may be undesirably reduced.

The product contacting layer also functions as a “heat sealing layer” or “heat sealable layer” which are used interchangeably herein to refer to a layer which is heat sealable i.e., capable of fusion bonding by conventional indirect heating means which generate sufficient heat on at least one film contact surface for conduction to the contiguous film contact surface and formation of a bond interface therebetween without loss of the film integrity. The bond interface between contiguous inner layers of the produced seal preferably has sufficient physical strength to withstand the packaging process and subsequent handling. Advantageously, the bond interface is preferably sufficiently thermally stable to prevent gas or liquid leakage therethrough when exposed to above or below ambient temperatures e.g. during one or more of the following: packaging operations, storage, handling, and transport.

As used throughout this application, the term “polypropylene” refers to a homopolymer or copolymer having a propyl or C-3 linkage between monomer units. A non-limiting example of a suitable propylene copolymer is Propylene 4170 available from Total Petrochemicals USA, Inc. (Houston, Tex.). Other non-limiting examples of polypropylenes include Polypropylene 3287WZ, which is available from Total Petrochemicals USA, Inc. (Houston, Tex.); and H02C-00 Polypropylene Homopolymer, which is available from Ineos Olefins & Polymers USA (League City, Tex.).

As used throughout this application, the term “polyester” refers to a homopolymer or copolymer having an ester linkage between monomer units which may be formed, for example, by condensation polymerization reactions between a dicarboxylic acid and a diol. The ester linkage can be represented by the general formula: [O—R—OC(O)—R′—C(O)]ₙ where R and R′ are the same or different alkyl (or aryl) group and may be generally formed from the polymerization of dicarboxylic acid and diol monomers containing both carboxylic acid and hydroxyl moieties. The dicarboxylic acid (including the carboxylic acid moieties) may be linear or aliphatic (e.g., lactic acid, oxalic acid, maleic acid, succinic acid, glutaric acid, adipic acid, pimelic acid, suberic acid, azelaic acid, sebacic acid, and the like) or may be aromatic or alkyl substituted aromatic (e.g., various isomers of phthalic acid, such as paraphthalic acid (or terephthalic acid), isophthalic acid and naphthalic acid). Specific examples of a useful diol include but are not limited to ethylene glycol, propylene glycol, trimethylene glycol, 1,4-butane diol, neopentyl glycol, cyclohexane diol and the like. Polyesters may include a homopolymer or copolymer of alkyl-aromatic esters including but not limited to polyethylene terephthalate (PET), amorphous polyethylene terephthalate (APET), crystalline polyethylene terephthalate (CPET), glycol-modified polyethylene terephthalate (PETG) and polybutylene terephthalate; a copolymer of terephthalate and isophthalate including but not limited to polyethylene terephthalate/isophthalate copolymer. Aliphatic esters include but not limited to polylactic acid (PLA); polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D); and blends of any of these materials. A non-limiting example of PETG is Eastar™ Copolyester 6763, which is also available from Eastman Chemical Company (Kingsport, Tenn.).

As used herein, the term “polylactic acid” is used synonymously throughout this disclosure to describe homopolymers or copolymers having an ester linkage between monomer units and can be represented by the general formula: [—OCH(R)C(O)—]ₙ where R═CH₃. Polylactic acid may be fabricated by polymerizing lactic acid, which is mostly produced from by carbohydrate fermentation of corn. Polylactic acid may be also produced by polymerization of lactide which obtained by condensation of two lactic acid molecules. Polylactic acid has a glass transition temperature ranging from 50° C. to 80° C., while the melting temperature ranges from 130° C. to 180° C. Polylactic acid is known by those skilled in the art and fully disclosed in U.S. Pat. Nos. 5,698,322; 5,142,023; 5,760,144; 5,593,778; 5,807,973; and 5,010,145, the entire disclosure of each of which is hereby incorporated by reference. Examples of commercially available polylactic acid are sold under the trademark NatureWorks™ PLA Polymer in grades 4031-D, 4032-D, and 4041-D from Cargill Dow LLC, Minneapolis, Minn., U.S.A.

As used throughout this application, the term “polystyrene” or “PS” refers to a homopolymer or copolymer having at least one styrene repeating linkage (such as benzene (i.e., C₆H₅) having an ethylene substituent) within the repeating backbone of the polymer. The styrene linkage can be represented by the general formula: [CH₂—CH₂ (C₆H₅)]ₙ. Polystyrene may be formed by any method known to those skilled in the art. Examples of styrenic polymers include but are not limited to high impact polystyrene (HIPS), general purpose polystyrene (GPPS) and styrene block copolymer (SBC). HIPS is sometimes called rubber-modified polystyrene and is normally produced by copolymerization of styrene and a synthetic rubber. (See Wagner, et al., “Polystyrene,” The Wiley Encyclopedia of Packaging Technology, Second Edition, 1997, pp. 768-771 (John Wiley & Sons, Inc., New York, N.Y.), which is incorporated in its entirety in this application by this reference.) Examples of HIPS include but are not limited to Impact Polystyrene 825E and Impact Polystyrene 945E, both of which are available from Total Petrochemicals USA, Inc; EB6025 Rubber Modified High Impact Polystyrene, which is available from Chevron Phillips Company (The Woodlands, Tex.); and 6210 High Impact Polystyrene, which is available from Ineos Nova LLC (Channahon, Ill.). GPPS is often called crystal polystyrene, as a reference to the clarity of the resin. Examples of GPPS include but are not limited to Crystal Polystyrene 524B and Crystal Polystyrene 525B, both of which are available from Total Petrochemicals USA, Inc. Styrene block copolymers (SBC) include styrene butadiene copolymers (SB). The styrene-butadiene copolymers that are suitable for packaging applications are those resinous block copolymers that typically contain a greater proportion of styrene than butadiene and that are predominantly polymodal with respect to molecular weight distribution. (See Hartsock, “Styrene-Butadiene Copolymers,” The Wiley Encyclopedia of Packaging Technology, Second Edition, 1997, pp. 863-864 (John Wiley & Sons, Inc., New York, N.Y.), which is incorporated in its entirety in this application by this reference.) A non-limiting example of SB is DK13 K-Resin® Styrene-Butadiene Copolymer, which is available from Chevron Phillips Chemical Company (The Woodlands, Tex.).

As used herein, the phrase “high density polyethylene” or “HDPE” refers to homopolymers of ethylene that have densities of about 0.960 g/cm³ to about 0.970 g/cm³ as well as copolymers of ethylene and an alpha-olefin (such as 1-butene or 1-hexene) that have densities of about 0.940 g/cm³ to about 0.958 g/cm³. In contrast, a low density polyethylene (LDPE) generally has a density of about 0.915 g/cm³ to about 0.930 g/cm³. HDPE is inclusive of polymers made with Ziegler or Phillips type catalysts and polymers made with single-site metallocene catalysts. A non-limiting example of high density polyethylene includes Alathon® M6020 from Equistar Chemicals LP (Houston, Tex.). Other specific non-limiting examples of HDPE include Alathon® M6020 available from Equistar Chemicals LP (Houston, Tex.); Alathon® L5885 available from Equistar Chemicals LP (Houston, Tex.); ExxonMobil™ HDPE HD 7925.30 available from ExxonMobil Chemical Company (Houston, Tex.); and ExxonMobil™ HDPE HD 7845.30 available from ExxonMobil Chemical Company (Houston, Tex.).

In one particular embodiment, first and second exterior layers 101 and 105 each independently include at least 50%, 75%, 90%, 91%, 92%, 93%, 94%, 95%, 96%, 97%, 98%, 99% or more cyclic olefin copolymer (COC) by weight relative to the total weight of the layer, and first and second interior layers 102 and 104 each comprise high density polyethylene (HDPE).

In another preferred embodiment, the first exterior layer 101 includes at least 50%, 75%, 90%, 91%, 92%, 93%, 94%, 95%, 96%, 97%, 98%, 99% or more cyclic olefin copolymer (COC) by weight relative to the total weight of the layer, the second exterior layer 105 comprises at least 50%, 60%, 70%, 80%, 90%, 95% or more of another material by weight relative to the total weight of the layer. The another material of the second exterior layer 105 may be at least one of polypropylene (PP), high impact polystyrene (HIPS), general purpose polystyrene (GPPS), styrene block copolymer (SBC), polyethylene terephthalate (PET), oriented polyethylene terephthalate (OPET), amorphous polyethylene terephthalate (APET), glycol-modified polyethylene terephthalate (PETG), or polylactic acid (PLA). The first and second interior layers 102 and 104 may each include high density polyethylene (HDPE) and have a thickness of at least 20%, 25%, 30%, 35% or more of the total thickness of the multilayer thermoplastic film 100. The first and second interior layers 102 and 104 may each have a thickness of between about 38.1 μm and about 190.5 μm (about 1.5 mil to about 7.5 mil).

In another particular embodiment, the first and second interior layers 102 and 104 each include a blend of a high density polyethylene and a high density polyethylene nucleation additive (HDPE-Blend). As used herein, the phrase “nucleation additive” means a material that increases high density polyethylene crystallinity as a result of its incorporation into HDPE. Such nucleation additives typically provide better control over crystallization rates. Examples of nucleation additives include minerals such as chalk, talc, clay, kaolin, silicates and the like, and organic agents such as salts of aliphatic or aromatic carboxylic acids, aromatic salts, metallic salts of aromatic phosphorous compounds, quinaridones, and aromatic amides. Further examples include zinc glycerolate, calcium glycerolate, calcium hexahydrophthalate, zinc hexahydrophthalate, salts and the like, and mixtures thereof. In one embodiment, the nucleation additive comprises calcium hexahydrophthalate. The nucleation additive may be present in each interior layer of HDPE in an amount from about 0.2% to about 3.5% by weight relative to the total weight of the layer.

In another embodiment, the first and second interior layers 102 and 104 each include a blend of a high density polyethylene, a high density polyethylene nucleation additive and/or a hydrocarbon resin (HDPE-Blend). The hydrocarbon resin may be present in the first and second interior layers 102 and 104 in an amount from about 3% to about 16% by weight relative to the total weight of the layer. As used herein, the phrase “hydrocarbon resin” refers to a product produced by polymerization from coal tar, petroleum, and turpentine feed stocks, as defined by ISO Standard 472, “Plastics—Vocabulary” incorporated by reference herein to the extent that it discloses hydrocarbon resins. A hydrocarbon resin may comprise any of those hydrocarbon resins disclosed in U.S. Pat. No. 6,432,496, issued Aug. 13, 2002, or in U.S. Patent Application 2008/0286547, published Nov. 20, 2008, both of which are incorporated in their entireties in this application by this reference. More specifically, as a non-limiting example, the hydrocarbon resin may include petroleum resins, terpene resins, styrene resins, cyclopentadiene resins, saturated alicyclic resins, or mixtures thereof. Additionally, as a non-limiting example, the hydrocarbon resin may include a hydrocarbon resin derived from the polymerization of olefin feeds rich in dicyclopentadiene (DCPD), from the polymerization of olefin feeds produced in the petroleum cracking process (such as crude C9 feed streams), from the polymerization of pure monomers (such as styrene, α-methylstyrene, 4-methylstyrene, vinyltoluene, similar pure monomer feedstocks, or any combination thereof), from the polymerization of terpene olefins (such as α-pinene, β-pinene, or d-limonene) or from a combination thereof. The hydrocarbon resin may be fully or partially hydrogenated. Specific examples of hydrocarbon resins include but are not limited to Plastolyn® R1140 Hydrocarbon Resin available from Eastman Chemical Company (Kingsport, Tenn.), Regalite® T1140 available from Eastman Chemical Company (Kingsport, Tenn.), Arkon® P-140 available from Arakawa Chemical Industries, Limited (Osaka, Japan) and Piccolyte® 5135 Polyterpene Resins available from Hercules Incorporated (Wilmington, Del.).

In another embodiment, the first and second interior layers 102 and 104 each include high density polyethylene having a bi-modal molecular weight distribution having a low molecular weight region and a high molecular weight region (HDPE-Bimodal).

The interior layers may be barrier layers. The interior layers may provide gas barrier functionality and moisture barrier functionality, and this functionality may be provided by a single barrier layer or by separate barrier layers.

A gas barrier layer may be an oxygen barrier layer. An oxygen barrier is preferably selected to provide a sufficiently limited oxygen permeability such that the packaged product is protected from undesirable deterioration or oxidative processes. For example, a film may comprise an oxygen barrier having an oxygen permeability that is low enough to prevent oxidation of oxygen sensitive products and substances to be packaged in the film—e.g., oxygen sensitive articles such as transdermal patches (such as nicotine or fentanyl patches). Preferably an oxygen barrier provides an oxygen permeability of less than or equal to 10 cm³/100 inches²/24 hours at 1 atmosphere and 23° C., such as less than 0.016 cm³/m² per 24 hours at 1 atmosphere. To protect oxygen sensitive articles from deterioration from oxygen contact over time the oxygen barriers of the base components according to the present invention may provide an oxygen transmission rate (O₂TR) of less than 1, preferably less than 0.1, more preferably less than 0.01, and most preferably less than 0.001 g/100 inches² at 24 hours at Room Temperature (RT) (−23° C.) and 1 atmosphere, such as <0.001 g/m² at 24 hours at RT and 1 atmosphere.

A moisture barrier may provide a sufficiently limited moisture permeability such that the packaged product is protected from undesirable deterioration. For example, a moisture barrier may have a moisture permeability that is low enough to prevent deleterious effects upon packaged products, such as transdermal drug patches or other moisture sensitive products. A preferred film according to various embodiments will have a water or moisture transmission rate (WVTR) of less than 0.01 g/100 inches² per 24 hours at Room Temperature (RT) (23° C.) and 1 atmosphere. In some embodiments, a film has a WVTR of less than 0.01 g/100 inches² per 24 hours at RT and 1 atmosphere, such as less than 0.001 g/100 inches² per 24 hours at RT and 1 atmosphere.

A barrier layer as described herein may include any suitable material. An oxygen barrier layer may include EVOH, polyvinylidene chloride, polyamide, polyester, polyalkylene carbonate, polyacrylonitrile, nanocomposite, a metallized film such as aluminum vapor deposited on a polyolefin, etc., as known to those of skill in the art. Suitable moisture barrier layers include aluminum foil, PVDC, or polyolefins such as LDPE or LLDPE. It is desirable that the thickness of the barrier layer be selected to provide the desired combination of the performance properties sought e.g. with respect to oxygen permeability, and delamination resistance, and water barrier properties. Suitable thicknesses of the barrier layer are less than 15%, e.g. from 3 to 13% of the total film thickness and preferably less than about 10% of the total thickness of the multilayer film. Greater thicknesses may be employed. For example, the thickness of an oxygen barrier layer may advantageously be less than about 0.45 mil (about 10.16 microns) and greater than about 0.05 mil (about 1.27 microns), including thicknesses of 0.10 mil, 0.20 mil, 0.25 mil, 0.30 mil, 0.40 mil, or 0.45 mil.

In one exemplary embodiment, the central core layer 103 comprises an ethylene vinyl acetate copolymer (EVA) and more preferably, an ethylene vinyl acetate copolymer (EVA) having a 12% by weight vinyl acetate content. Non-limiting examples of EVA include Escorene™ Ultra LD 705.MJ available from ExxonMobil Chemical Company (Houston, Tex.), Escorene™ Ultra LD 768.MJ available from ExxonMobil Chemical Company (Houston, Tex.) and Ateva® 2861AU available from Celanese Corporation (Edmonton, Alberta, Canada).

Exemplary five-layer embodiments of the base component described above may include, but are not limited to the following layer sequences and general layer compositions: COC/HDPE/EVA/HDPE/COC; COC/HDPE-Blend/EVA/HDPE-Blend/COC; COC/HDPE-Bimodal/EVA/HDPE-Bimodal/COC; COC/HDPE/EVA/HDPE/PP; COC/HDPE-Blend/EVA/HDPE-Blend/PP; COC/HDPE-Bimodal/EVA/HDPE-Bimodal/PP; COC/HDPE/EVA/HDPE/PETG; COC/HDPE-Blend/EVA/HDPE-Blend/PETG; COC/HDPE-Bimodal/EVA/HDPE-Bimodal/PETG; COC/HDPE/EVA/HDPE/APET; COC/HDPE-Blend/EVA/H DPE-Blend/APET; COC/HDPE-Bimodal/EVA/HDPE-Bimodal/APET; COC/HDPE/EVA/HDPE/PET; COC/HDPE-Blend/EVA/HDPE-Blend/PET; COC/HDPE-Bimodal/EVA/HDPE-Bimodal/PET; COC/HDPE/EVA/HDPE/OPET; COC/HDPE-Blend/EVA/HDPE-Blend/OPET; COC/HDPE-Bimodal/EVA/HDPE-Bimodal/OPET; COC/HDPE/EVA/HDPE/PLA; COC/HDPE-Blend/EVA/HDPE-Blend/PLA; COC/HDPE-Bimodal/EVA/HDPE-Bimodal/PLA; COC/HDPE/EVA/HDPE/HIPS; COC/HDPE-Blend/EVA/HDPE-Blend/HIPS; COC/HDPE-Bimodal/EVA/HDPE-Bimodal/HIPS; COC/HDPE/EVA/HDPE/GPPS; COC/HDPE-Blend/EVA/HDPE-Blend/GPPS; COC/HDPE-Bimodal/EVA/HDPE-Bimodal/GPPS; COC/HDPE/EVA/HDPE/SBC; COC/HDPE-Blend/EVA/HDPE-Blend/SBC; and COC/HDPE-Bimodal/EVA/HDPE-Bimodal/SBC.

The above examples may further include a tie layer comprising a tie layer material, such as between a high density polyethylene layer and the second exterior layer. The term “tie layer,” or “adhesive layer,” refers to a layer or material placed on one or more layers to promote the adhesion of that layer to another surface. Preferably, adhesive layers are positioned between two layers of a multilayer film to maintain the two layers in position relative to each other and prevent undesirable delamination. In some embodiments a peelable tie layer may be used which is designed to have either cohesive failure or delamination from one or both adjacent layers upon application of a suitable manual force to provide an opening feature for a package made from the film. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer film may comprise components of both the first layer and the second layer to promote simultaneous adhesion of the adhesive layer to both the first layer and the second layer to opposite sides of the adhesive layer. Tie layer materials may include, but are not limited to, unmodified polyolefins such as polyethylenes and ethylene vinyl acetate copolymers, unmodified ester copolymers such as ethylene acrylate copolymers and ethylene methacrylate copolymers, unmodified ethylene acid copolymers such as ethylene acrylic acid copolymers, and blends thereof. Tie layer materials may also include modified polyolefins including, but not limited to anhydride modified polyethylenes, anhydride modified ethylene vinyl acetate copolymers, modified ester copolymers such as anhydride modified ethylene acrylate copolymers, modified ethylene acid copolymers such as anhydride modified ethylene acrylic acid copolymers, and blends thereof. Tie layer materials may further include a blend of an unmodified polyolefin, unmodified ester copolymer, or unmodified ethylene acid copolymer and a modified polyolefin, modified ester copolymer, or modified ethylene acid copolymer. In a preferred embodiment, a tie layer may be present between a layer comprising high density polyethylene and the second exterior layer comprising polypropylene (PP), high impact polystyrene (HIPS), general purpose polystyrene (GPPS), styrene block copolymer (SBC), polyethylene terephthalate (PET), oriented polyethylene terephthalate (OPET), amorphous polyethylene terephthalate (APET), glycol-modified polyethylene terephthalate (PETG) or polylactic acid (PLA).

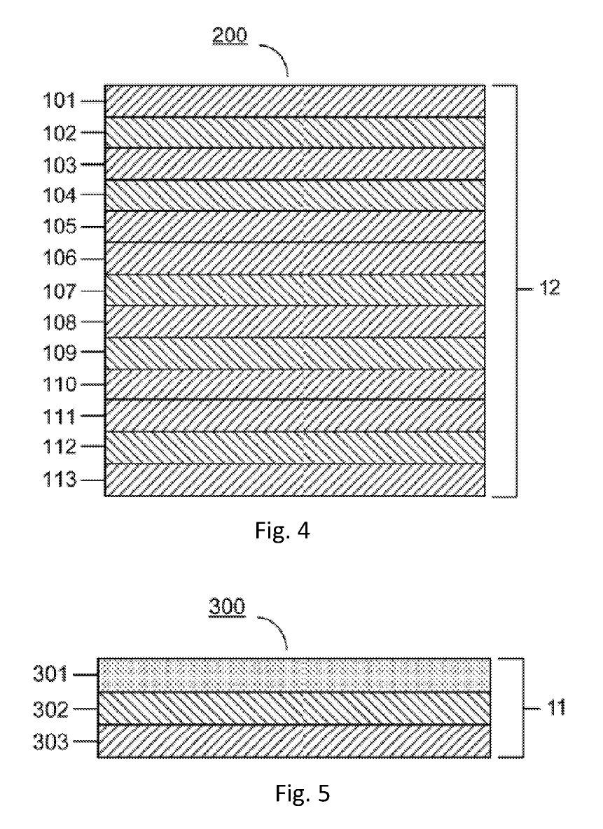

In another exemplary embodiment as depicted in FIG. 4, thermoformed base component 12 comprises a multilayer palindromic thermoplastic film 200 which comprises a thirteen-layer symmetrical structure of a first exterior layer 201, a first interior layer 202, a second interior layer 203, a third interior layer 204, a fourth interior layer 205, a fifth interior layer 206, a sixth interior layer 207, a central core layer 208, a seventh interior layer 209, an eighth interior layer 210, a ninth interior layer 211, a tenth interior layer 212, an eleventh interior layer 213, and a second exterior layer 214. In this embodiment, film 200 comprises two exterior layers each comprising cyclic olefin copolymer (COC), two discrete interior layers each comprising ethylene vinyl alcohol copolymer (EVOH), and four discrete interior layers each comprising high density polyethylene (HDPE). This thirteen-layer embodiment has the following layer sequence and general layer composition: COC/HDPE/tie/EVOH/tie/HDPE/EVA/HDPE/tie/EVOH/tie/HDPE/COC. The HPDE containing layers may include a HDPE nucleation additive and a hydrocarbon resin, and provide moisture barrier functionality. The EVOH containing layers provide oxygen barrier functionality.

The total thickness of multilayer thermoplastic films of the thermoformed base component 12 of the present invention is generally from about 12.7 μm (0.5 mil) to about 508 μm (20 mil), such as from about 50.8 μm (2 mil) to about 254 μm (10 mil), or from about 76.2 μm (3 mil) to about 203.2 μm (8 mil).

### Lidding Component

The packages of the present invention also include a lidding component which includes a cyclic olefin copolymer product contacting layer that is heat-sealable to the product contacting layer of the base component.

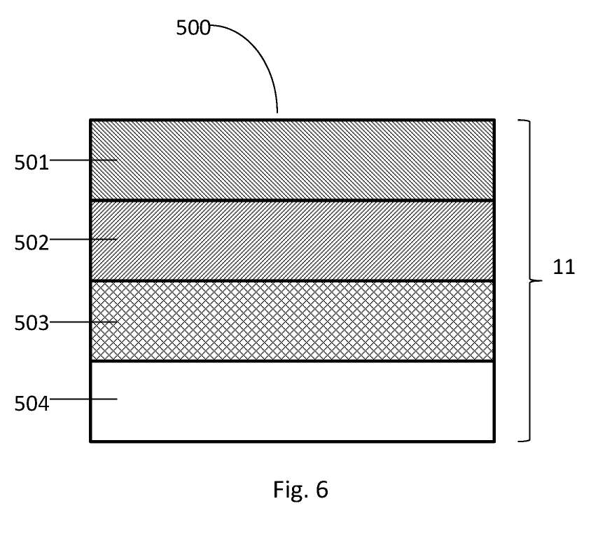

One exemplary embodiment of a lidding component 11 is depicted in FIG. 5. In this embodiment, lidding component 11 comprises a laminate 300 having a first exterior layer 301, an interior layer 302 and a second exterior layer 303. The second exterior layer 303 is a product contacting layer that includes at least 50% by weight of a cyclic olefin copolymer relative to the total weight of the layer, the first exterior layer 301 comprises paper, biaxially oriented nylon, biaxially oriented polypropylene, or oriented polyethylene terephthalate, and interior layer 302 comprises a metal foil such as aluminum. A tie or adhesive layer disposed between and bonding exterior layer 301 and interior layer 302 together may also be provided.

The second exterior layer 303 may include at least 50%, 75%, 90%, 91%, 92%, 93%, 94%, 95%, 96%, 97%, 98%, 99% or more cyclic olefin copolymer (COC) by weight relative to the total weight of the layer. In one embodiment, the second exterior layer may consist of a cyclic olefin copolymer. The COC contained in the second exterior layer 303 may be any of those described above. The COC contained in the lidding component may be the same as the COC contained in the base component. Alternatively, the COC contained in the lidding component may be different than the COC contained in the base component.

The exterior layer may be any appropriate material. For example, the exterior layer may include paper, biaxially oriented nylon, biaxially oriented polypropylene, or oriented polyethylene terephthalate. The exterior layer may serve to protect the lidding component from damage and/or to provide additional strength to the lidding component.

The interior layer may be any appropriate metal foil. For example, the interior layer may be an aluminum foil. The metal foil may have a thickness of on the order of about 25.4 μm (about 1 mil). The foil serves as a barrier layer. The functions of the interior layer and the first exterior layer may be combined in a single layer, such as in a lidding component that includes only a barrier layer and a product contacting layer.

The lidding component may be produced using an extrusion coating apparatus and methods which are well known to those skilled in the art. The extrusion coating apparatus may include a multi-manifold flat die head through which a two-layer film composition may be forced and extrusion coated onto the shiny surface of a metallic foil. The metallic foil may be pre-treated prior to extrusion coating by printing a primer coat onto the matte surface of the foil. An exterior layer, such as paper or oriented polyethylene terephthalate, may be attached to the foil before or after the extrusion coating process.

In another exemplary embodiment as depicted in FIG. 6, lidding component 11 includes a multilayer film 500 which has a four-layer structure of a first exterior layer 501, a first interior layer 502, a second interior layer 503, and a second exterior layer 504. In this embodiment, first exterior layer 501 includes paper or oriented polyethylene terephthalate. The first interior layer 502 includes a polyethylene extrudate or adhesive, and the second interior layer 503 includes a metal foil. The second exterior layer 504 is a COC containing product contact layer of the type described above. This four-layer embodiment of the lidding component has the following layer sequence and general layer composition: COC/PE/foil/COC. An additional tie or adhesive layer may optionally be present between the second interior layer 503 and the second exterior layer 504.

### Package

The packages as described herein can be manufactured using methods known in the art. Generally, the cavities are thermoformed from the base components of the present invention in-line just prior to filling the cavities with a product to be packaged. The thermoformed cavities may have any appropriate geometry, and are not limited to the specific configuration illustrated in FIG. 1 (e.g., the package may have a greater or lesser number of compartments, the compartments may have different sizes and/or shapes, etc.). The lidding component is then unwound from a roll and brought into contact with the formed and filled base component such that the cyclic olefin copolymer product contacting layer of the lidding component contacts the cyclic olefin copolymer product contacting layer of the base component. The lidding and base components are heat sealed, typically using a heated platen. Some areas of the package may not be sealed to provide a starting point for peeling off the lidding component prior to removing the product. If the lidding component is not pre-printed, printing is generally done just before heat sealing. After heat-sealing, the individual cavities may be perforated using methods known is the art so that they can removed at point of use.

The packages as described herein may alternatively include a base component in the form of a tray or a container. The tray or container base portions may be formed by any appropriate process, and may have any appropriate geometry. For example, a cold forming process may be utilized to form a container from a base component, with the container being subsequently sealed to the lidding component to form a complete container and lid package.

The seal between the lidding component and the base component has a seal strength of at least 800 grams force per inch, such as at least about 1,000 grams force per inch, at least about 1,200 grams force per inch, or more. The seal produced between the COC-containing product contacting layers of the base component and the lidding component is significantly stronger than that of a COC-containing layer heat sealed to a polyvinylchloride (PVC) layer or polyacrylate layer. For example, layers that contain at least 50% by weight COC may produce seal peel strengths of only about 200 gf when heat sealed with polyvinylchloride (PVC) layers or polyacrylate layers, and such a seal strength may be insufficient for some package applications. The sealing of the lidding component to the base component produces a cavity where all of the surfaces exposed to the product are formed by the cyclic olefin copolymer product contacting layers of the lidding component or the base component. In this manner, the packages disclosed herein provide cavities in which every surface exposed to the product is formed of an anti-scalping material, while also providing the desired seal strength. The strength of the seal may be influenced by the design of the package, such as the geometry, and the product requirements.

The packages described herein may be utilized as packaging for nicotine containing products. Examples of nicotine containing products include nicotine cartridges for electronic cigarettes, nicotine gum, and nicotine transdermal patches. The cyclic olefin copolymer product contacting layers of the lidding component and the base component resist the uptake of nicotine, enhancing the shelf life and efficiency of the package. The packages may also be utilized as packaging for other products, such as pharmaceuticals or medications. A pharmaceutical product for packaging in a package described herein can include any suitable pharmaceutical active agent. In some embodiments, the pharmaceutical active agent is selected from the group consisting of fentanyl, nicotine, lidocaine, estradiol, clonidine, ethinyl estradiol, oxybutynin, buprenorphine, granisitron, methylphenidate, and scopolamine. In some embodiments, one or more of the listed pharmaceutical active agents are included in a pharmaceutical product, such as a transdermal patch.

### Non-Limiting Examples

Blister packages with COC-containing product contacting layers of the type described herein were tested to determine the degree of nicotine uptake in the packaging. The product contacting layers were formed from a commercially available CXB™ sealant layer structure on a SKYBLUE™ blister packaging film, the product contacting layers were 100% by weight COC. A blister package with product contacting layers of polychlorotrifluoroethylene (PCTFE) and polyvinylchloride (PVC) was utilized as a control. The same amount of nicotine was placed in each blister package, and the amount of nicotine uptake in the test blister packaging materials, after washing out the nicotine from the blister package, was measured after 1 week, 2 weeks, and 4 weeks of elapsed time.

As shown in Table 1, the blister packages with COC-containing product contacting layers exhibited significantly less uptake of nicotine than the control blister packages with PVC product contacting layers. Thus, the blister packages with COC-containing product contacting layers of the present invention exhibited greater resistance to nicotine scalping than other common blister packages, such as those with PCTFE and PVC product contacting layers.

TABLE 1

| | Nicotine Uptake (mg) | | |
|---|---|---|---|
| Blister Package | Week 1 | Week 2 | Week 4 |
| PCTFE/PVC | 9.11 | 16.74 | 17.13 |
| COC (SKYBLUE ™ | 0.71 | 0.62 | 1.00 |
| CXB ™ film) | | | |

As used herein, singular forms “a,” “an” and “the” include plural referents unless the context clearly dictates otherwise. Thus, for example, reference to a “structured bottom surface” includes examples having two or more such “structured bottom surfaces” unless the context clearly indicates otherwise.

As used herein, the term “or” is generally employed in its sense including “and/or” unless the content clearly dictates otherwise. The term “and/or” means one or all of the listed elements or a combination of any two or more of the listed elements. The use of “and/or” in certain instances herein does not imply that the use of “or” in other instances does not mean “and/or”.

As used herein, “have”, “has”, “having”, “include”, “includes”, “including”, “comprise”, “comprises”, “comprising” or the like are used in their open ended inclusive sense, and generally mean “include, but not limited to”, “includes, but not limited to”, or “including, but not limited to”.

“Optional” or “optionally” means that the subsequently described event, circumstance, or component, can or cannot occur, and that the description includes instances where the event, circumstance, or component, occurs and instances where it does not.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the inventive technology.

For purposes of the present disclosure, recitations of numerical ranges by endpoints include all numbers subsumed within that range (e.g., 1 to 5 includes 1, 1.5, 2, 2.75, 3, 3.80, 4, 5, etc.). Where a range of values is “greater than”, “less than”, etc. a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles or systems described herein may be used in a number of directions and orientations.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It is also noted that recitations herein refer to a component being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

While various features, elements or steps of particular embodiments may be disclosed using the transitional phrase “comprising,” it is to be understood that alternative embodiments, including those that may be described using the transitional phrases “consisting” or “consisting essentially of,” are implied.

In the foregoing description, it will be readily apparent to one skilled in the art that varying modifications may be made to the present disclosure without departing from the scope and spirit of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents. The embodiments illustratively described herein suitably may be practiced in the absence of any element or elements, limitation or limitations, which is not specifically disclosed herein. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention. Thus, it should be understood that although the present invention has been illustrated by specific embodiments and optional features, modification and/or variation of the concepts herein disclosed may be resorted to by those skilled in the art, and that such modifications and variations are considered to be within the scope of this invention.

What is claimed is:

1. A package comprising:
a base component comprising a product contacting layer comprising at least 50% by weight of a cyclic olefin copolymer; and
a lidding component comprising a product contacting layer comprising at least 50% by weight of a cyclic olefin copolymer;
wherein the product contacting layer of the base component is sealed to the product contacting layer of the lidding component such that a cavity is formed.

2. The package of claim 1, wherein the base component is a multilayer thermoplastic film that comprises:
the product contacting layer comprising at least 50% by weight of the cyclic olefin copolymer,
a first interior layer,
a core layer,
a second interior layer, and
an exterior layer comprising at least one material selected from the group consisting of cyclic olefin copolymer (COC), polypropylene (PP), high impact polystyrene (HIPS), general purpose polystyrene (GPPS), styrene block copolymer (SBC), polyethylene terephthalate (PET), oriented polyethylene terephthalate (OPET), amorphous polyethylene terephthalate (APET), glycol-modified polyethylene terephthalate (PETG), biaxially oriented nylon (BON), and polylactic acid (PLA).

3. The package of claim 2, wherein the first interior layer and the second interior layer each comprise at least one of a high density polyethylene nucleation additive or a hydrocarbon resin.

4. The package of claim 2, wherein the first interior layer and the second interior layer each comprise a bimodal high density polyethylene having a distribution of a low molecular weight region and a high molecular weight region.

5. The package of claim 2, wherein the core layer comprises an ethylene vinyl acetate copolymer.

6. The package of claim 2, wherein the exterior layer of the base component comprises at least 50% by weight of a cyclic olefin copolymer.

7. The package of claim 1, wherein the cyclic olefin copolymer of at least one of the base component or the lidding component comprises norbornene and ethylene monomers.

8. The package of claim 1, wherein the lidding component comprises:
a barrier layer; and
the product contacting layer comprising at least 50% by weight of a cyclic olefin copolymer.

9. The package of claim 8, wherein the lidding component further comprises an exterior layer disposed over the barrier layer that comprises at least one of paper, biaxially oriented nylon, biaxially oriented polypropylene, or oriented polyethylene terephthalate.

10. The package of claim 14, wherein the lidding component further comprises an interior layer disposed between the exterior layer and the barrier layer that comprises at least one of polyethylene and an adhesive.

11. The package of claim 1, wherein the seal between the product contacting layer of the base component and the product contacting layer of the lidding component has a seal strength of at least 800 grams force per inch.

12. A lidding component for a package comprising:
a barrier layer; and
a product contacting layer comprising at least 50% by weight of a cyclic olefin copolymer, wherein the product contacting layer is configured to seal to a product contacting layer of a base component.

13. The lidding component of claim 19, further comprising an exterior layer disposed over the barrier layer that comprises at least one of paper, biaxially oriented nylon, biaxially oriented polypropylene, or oriented polyethylene terephthalate.

14. The lidding component of claim 13, further comprising an interior layer disposed between the exterior layer and the barrier layer that comprises at least one of polyethylene and an adhesive.

15. A method of forming a package, comprising:
sealing a product contacting layer comprising at least 50% by weight of a cyclic olefin copolymer of a base component to a product contacting layer comprising at least 50% by weight of a cyclic olefin copolymer of a lidding component to form a cavity.

16. The method of claim 15, further comprising forming the base component by a blown coextrusion process and forming the lidding component by a lamination process.

17. The method of claim 15, wherein the sealing is a heat sealing process.

18. The method of claim 15, wherein the base component is a multilayer thermoplastic film that comprises:
a product contacting layer comprising at least 50% by weight of the cyclic olefin copolymer,
a first interior layer,
a core layer,
a second interior layer, and
an exterior layer comprising at least one material selected from the group consisting of cyclic olefin copolymer (COC), polypropylene (PP), high impact polystyrene (HIPS), general purpose polystyrene (GPPS), styrene block copolymer (SBC), polyethylene terephthalate (PET), oriented polyethylene terephthalate (OPET), amorphous polyethylene terephthalate (APET), glycol-modified polyethylene terephthalate (PETG), biaxially oriented nylon (BON), and polylactic acid (PLA).

19. The method of claim 18, wherein the exterior layer of the base component comprises at least 50% by weight of a cyclic olefin copolymer.

20. The method of claim 15, wherein the lidding component comprises:
a barrier layer; and
the product contacting layer comprising at least 50% by weight of a cyclic olefin copolymer.

21. The method of claim 20, wherein the lidding component further comprises an exterior layer disposed over the barrier layer that comprises at least one of paper, biaxially oriented nylon, biaxially oriented polypropylene, or oriented polyethylene terephthalate.

22. The method of claim 15, wherein the lidding component further comprises an interior layer disposed between the exterior layer and the barrier layer that comprises at least one of polyethylene and an adhesive.
